(19) United States
(12) Patent Application Publication
(10) Pub. No.: US 2011/0002469 A1
(43) Pub. Date: Jan. 6, 2011

(54) Apparatus for Capturing and Rendering a Plurality of Audio Channels

(75) Inventor: Pasi Ojala, Kirkkonummi (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/920,946

(22) PCT Filed: Mar. 3, 2008
(86) PCT No.: PCT/EP2008/052575

§ 371 Date: Sep. 3, 2010

(51) Int. Cl. H04R 5/00

(52) U.S. Cl. 381/22; 381/19; 381/23

(57) ABSTRACT

A method comprising selecting a subset of audio sources from a plurality of audio sources, and transmitting signals from said selected subset of audio sources to an apparatus, wherein said subset of audio sources is selected in dependence on information provided by said apparatus.

### FIELD OF THE INVENTION

The present invention relates to an apparatus for audio capture and audio rendering, and more specifically but not exclusively to the transmission of real-time multimedia over a packet switched network.

### BACKGROUND

Several beam forming methods for estimating the audio signal direction of arrival and concentrating on a certain direction by weighting the outputs of the microphone array appropriately are known. The applications of these methods range from submarine audio surveillance to active noise cancellation in mobile phones.

In order to be used in a beam forming method, the microphone array needs to be carefully assembled, in particularly, regarding the relative positions of microphones since the beam forming functionality depends on the phase differences in the output of the sensors. Furthermore, to be able to utilise the phase differences, the distance of microphones is limited by the wavelength of the audio signals being received, i.e. the distance between sensors must be smaller than half the wavelength.

The output of a typical beam forming microphone array is a mono signal. The output of each individual sensor is added together after they have been weighted and delayed appropriately according to the beam forming purposes. Hence, there is no multi channel audio available after the beam forming since output consists of a single channel audio and direction of arrival which corresponds to the microphone array settings. Therefore, any post processing consisting of further analysis or exploration of the audio scene is not possible at the receiving entity.

Existing direction selective recordings are commonly conducted using either beam forming techniques applied to the output of known microphone arrays of closely based microphones or by using large scale microphone arrays selected from a microphone grid covering the audio scene of interest.

The source selection as well as source tracking may be performed using beam forming. For example, the Ambisonic technique requires a well defined microphone setting using e.g. coincided microphone setting for creating directional information on the captured audio.

It is possible that a sensor array or matrix may be formed on an ad hoc basis e.g. with a network of mobile phones. In such an arrangement the sensor position is not known, and this may cause difficulties for beam forming algorithms. However, the location information for each sensor, if available, could be attached to each channel for further analysis in the receiving terminal. The microphone location information may also be needed in order to generate a multi channel audio representation. That is, panning the audio content onto various loudspeaker configurations requires knowledge on the intended locations of the sound sources. This is especially true when there is correlation between the audio sources.

The MPEG standards body is currently examining object based audio coding. The intention of object based audio encoding is similar to traditional surround sound audio coding. However, the object based encoder receives the individual input signals (or objects) and produces one or more down mix signals plus a stream of side information. On the receiving side, the decoder produces a set of object outputs that are passed into a mixer/rendering stage that generates an output for a desired number of output channels and speaker setup. The parameters of this mixer/renderer can be varied in dependence on user inputs and thus enable real-time interactive audio composition.

The audio objects used in object based audio coding may be locations in the audio scene based on the user preference. FIG. 1 presents a basic object based coder architecture. In the architecture shown in FIG. 1, a multi-channel/object encoder 2 receives a plurality of input audio channel/object signals and encodes the signals for transmission. The encoded signals are received at a multi-channel/object decoder 4 that decodes the received signal into the original input audio channel/object signals. A mixer/renderer 6 receives the decoded audio channels/objects from the decoder 4 and also receives a user interaction signal 8. The mixer/renderer generates a number of output audio channels/objects in dependence on the decoded audio channels/objects and the user input 8.

The number of output audio channels/objects does not need to be identical to the number of input channels/objects. For example, the output of the mixer/renderer 6 could be intended for any loudspeaker output configuration from stereo to N channel output. Furthermore, the output could be rendered into binaural format for headphone listening.

A related concept for object based audio coding called Personalised Audio Service (PAS) has been initiated for object based audio processing. In a conventional multi-channel audio application, only a single prearranged audio scene is provided for the user. Hence, there is no flexibility to control the audio representation. However, the PAS concept delivers unbundled audio objects that can be used to create a personalized sound scene by applying user interactions or control signals. This means that users are able to control properties of audio objects such as loudness, direction and distance to create his/her own audio scene according to their requirements. The main target of PAS systems is for broadcasting services. A further scenario considered by the PAS concept is to provide user preference and interactivity of audio control.

FIG. 2 presents the PAS concept with independent audio objects for flexible rendering. The similarities to the architecture of FIG. 1 are evident in the PAS concept as illustrated in FIG. 2. A plurality of audio channels or objects covering an audio scene are encoded for transmission in an encoder 2. The transmitted signals are received at a decoder 4 and decoded in to the constituent audio channels/objects. And the desired audio scene is then rendered in dependence on the decoded audio channels/objects and the user interaction 8.

The user may be able to control the 3D spatial information such as location and intensity, etc. In addition, the user may select among several available 3D scenes.

However, in the case of the architectures of each of FIGS. 1 and 2 it is necessary to send information relating to each of the audio objects in the audio scene to be reproduced. This is true even if an object is not used in the rendering of the final audio scene according to the user preference. Furthermore, isolating individual objects from the audio scene requires the use of directional beam forming techniques, and thus places strict limits on the placement of the microphones used to monitor the original audio scene. This also means that it is not possible to make use of an ad-hoc network of microphones in conjunction with the architectures of FIGS. 1 and 2.

It is an aim of some embodiments of the present invention to address, or at least mitigate, some of these problems.

### SUMMARY

According to a first aspect of the present invention, there is provided a method comprising selecting a subset of audio sources from a plurality of audio sources, transmitting signals from said selected subset of audio sources to an apparatus, wherein said subset of audio sources is selected in dependence on information provided by said apparatus.

According to one embodiment, the method may further comprise encoding said signals from said subset of audio sources before transmission. Said plurality of audio sources may comprise a plurality of microphones in a microphone lattice or they may comprise a microphone array suitable for beam forming. The information provided by said apparatus may comprise virtual listener coordinates or may comprise. The method may further comprise providing configuration information relating to said plurality of audio sources to said apparatus. Said information provided by said apparatus may be generated in dependence on said configuration information relating to said plurality of audio sources. Said configuration information may comprise relative positional information relating to said audio sources. Said configuration information may comprise orientation information relating to said audio sources

According to a further aspect of the present invention, there is provided a method comprising generating information relating a desired subset of audio sources from a plurality of audio sources, supplying said information to an apparatus, and receiving signals transmitted by said apparatus.

According to an embodiment of the present invention, the disclosed method may further comprise decoding said received signals to synthesize a plurality of audio channels relating to said desired subset of audio sources. The method may further comprise rendering said synthesized audio channels to provide a desired audio scene. Said information relating to a desired subset of audio sources may comprise virtual listener coordinates or may comprise audio source selection information. The method may further comprise receiving configuration information relating to the configuration of said plurality of audio sources. Said information relating to a desired subset of audio sources may be generated in dependence on said configuration information. Said configuration information comprises relative positional information relating to said audio sources. Said configuration information may comprise orientation information relating to said audio sources. Rendering the synthesized audio channels may further comprise rendering said synthesized signals to provide a desired audio scene in dependence on said configuration information relating to said plurality of audio sources.

According to a further aspect of the present invention, there is provided an apparatus comprising an audio source selector configured to select a subset of a plurality of audio sources in dependence on information provided by a further apparatus, and an encoder configured to encode signals from said subset of audio sources and to transmit said encoded signal to said further apparatus.

According to an embodiment of the present invention, said plurality of audio sources may comprise a plurality of microphones in a microphone lattice, or the plurality of audio sources may comprise a microphone array suitable for beam forming. Said information provided by said further apparatus may comprise virtual listener coordinates or it may comprise audio source selection information. The apparatus may further comprise comprising a providing unit configured to provide configuration information relating to said plurality of audio sources to said further apparatus. Said configuration information may comprise relative positional information relating to said audio sources. Said configuration information may comprise orientation information relating to said audio sources.

According to a further aspect of the present invention, there is provided an apparatus comprising a controller configured to provide information relating to a desired audio scene to a further apparatus, and a decoder configured to receive an encoded signal from said further apparatus and decode the signal.

According to an embodiment of the present invention, the apparatus may further comprise a renderer configured to receive decoded signals from said decoder, and wherein said controller is further configured to provide a control signal to said renderer, said renderer further configured to generate a desired audio scene in dependence on said decoded signal and said control signal. Said information relating to a desired subset of audio sources may comprise virtual listener coordinates or source selection information. Said controller may be further configured to receive configuration information relating to the configuration of said plurality of audio sources. Said configuration information may comprise relative positional information relating to said audio sources. Said configuration information may comprise orientation information relating to said audio sources

According to a further aspect of the present invention, there is provided an apparatus comprising controlling means for providing information relating to a desired audio scene to a further apparatus, and decoding means for receiving an encoded signal from said further apparatus, and for decoding the signal.

According to a further aspect of the present invention, there is provided an apparatus comprising selecting means for selecting a subset of a plurality of audio sources in dependence on information provided by a further apparatus, and encoding means for encoding signals from said subset of audio sources and for transmitting said encoded signal to said further apparatus.

According to a further aspect of the present invention, there is provided a computer program code means adapted to perform any of the steps of the disclosed method when the program is run on a processor.

According to a further aspect of the present invention, there is provided an electronic device, or a chipset comprising the disclosed apparatus.

### BRIEF DESCRIPTION OF THE DRAWINGS

Embodiments of the present invention will now be described by way of example only with reference to the accompanying Figures, in which:

FIG. 1 illustrates a prior art object based audio coding and rendering system;

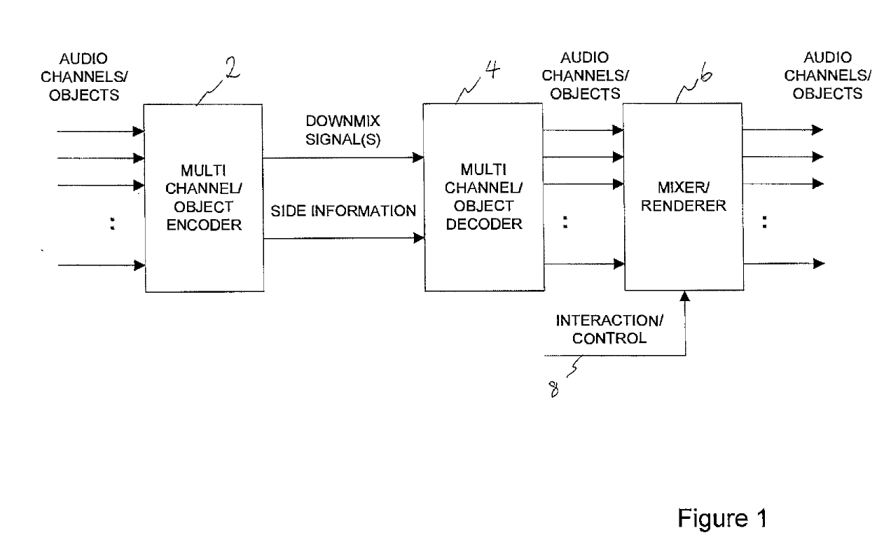

FIG. 2 illustrates a prior art system embodying the Personalised audio service concept;

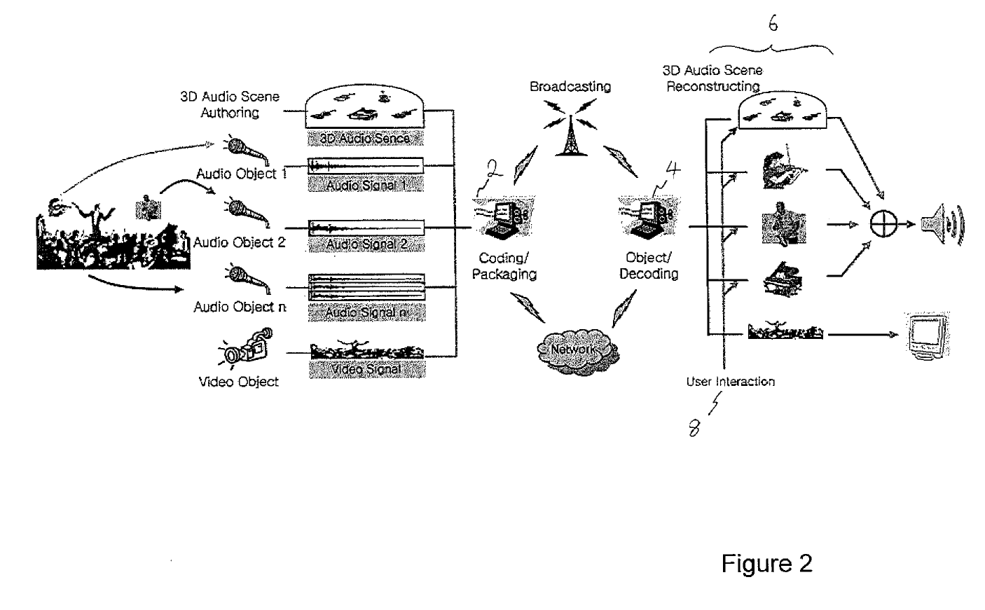

FIG. 3 illustrates a user equipment suitable for implementing elements of the present invention;

FIG. 4 illustrates a microphone lattice with a virtual path of a listener according to an embodiment of the present invention;

FIG. 5 illustrates a system for selecting microphones in a microphone lattice in accordance with an embodiment of the present invention;

FIG. 6 illustrates a multi channel/object based audio coding system with a feedback loop for channel/object selection in accordance with an embodiment of the present invention; and

FIG. 7 illustrates a method according to one embodiment of the present invention;

### DESCRIPTION OF PREFERRED EMBODIMENTS

Embodiments of the present invention are described herein by way of particular examples and specifically with reference to preferred embodiments. It will be understood by one skilled in the art that the invention is not limited to the details of the specific embodiments given herein.

According to an embodiment of the present invention, multi-channel audio information from an arbitrary sensor configuration may be transmitted using selective multi-channel audio encoding. A subset of a plurality of input channels provided by a microphone array or lattice may be selected after which the signal may be encoded, for example using BCC coding, MPEG Spatial Audio Coder (SAC) also known as MPS, MPEG Spatial Object-based Audio Coder (SAOC) or Directional Audio Coding (DirAC). According to one embodiment of the present invention, only two channels may be selected, allowing more straightforward stereo coding to be used.

According to one embodiment of the invention, in order to encode the multi-channel content efficiently, it may be necessary to provide information describing the relative positions of the microphones within the microphone array. Furthermore, the information on the audio sources, such as the relative positions, may be useful in generating representations of the audio content.

For example, representation of the audio scene using an arbitrary loudspeaker configuration, such as 5.1, may require panning of the audio sources onto the speaker locations. When the listener position relative to the microphone locations is known the sources may be panned to any arbitrary loudspeaker configuration. Alternatively, headphone listening with binaural representation may be supported.

According to an embodiment of the present invention, information relating to the microphone configuration, for example relative position and orientation, may be used in determining and controlling a desired position of the listener within the audio scene. In one example embodiment, the layout of the microphone network may change with time. In order to allow for such changes, updates of the configuration information may be required at a sufficient rate to allow for the dynamic nature of the capture layout to be managed.

According to one embodiment of the present invention, the audio scene may be captured using an array or lattice of microphones arranged in an arbitrary configuration. As the point of interest may be covered with a plurality of microphones, the audio scene may be explored by either using beam forming techniques or by multi microphone recording. For the use of beam forming techniques, as previously mentioned, it is necessary for the microphone array to be well defined, and there are strict requirements as to the distances between the microphones. According to one example embodiment, processing relating to the beam forming may be conducted at a receiver based on the user control, the required microphone data being supplied to the receiver for use in the beam forming calculations.

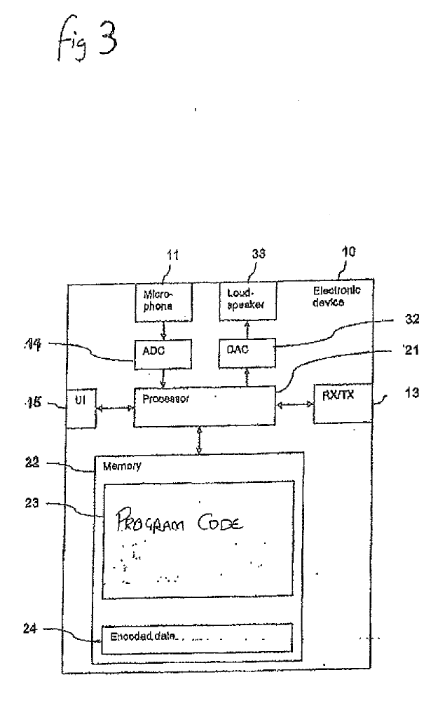

Reference is first made to FIG. 3 showing a schematic block diagram of an exemplary electronic device 10, which may incorporate a codec according to an embodiment of the invention. The electronic device 10 may, for example, be a mobile terminal or user equipment of a wireless communication system.

The electronic device 10 comprises a microphone 11, which is linked via an analogue-to-digital converter 14 to a processor 21. The processor 21 is further linked via a digital-to-analogue converter 32 to loudspeakers 33. The processor 21 is further linked to a transceiver (TX/RX) 13, to a user interface (UI) 15 and to a memory 22.

The processor 21 may be configured to execute various program codes. The implemented program codes may comprise an audio decoding code, and mixer/rendering code. The implemented program codes 23 may be stored for example in the memory 22 for retrieval by the processor 21 whenever needed. The memory 22 could further provide a section 24 for storing data, for example data that has been encoded in accordance with the invention. The implemented program codes may in embodiments of the invention be implemented in hardware or firmware.

The user interface 15 enables a user to input commands to the electronic device 10, for example via a keypad, and/or to obtain information from the electronic device 10, for example via a display. The transceiver 13 enables a communication with other electronic devices, for example via a wireless communication network.

It is to be understood again that the structure of the electronic device 10 could be supplemented and varied in many ways.

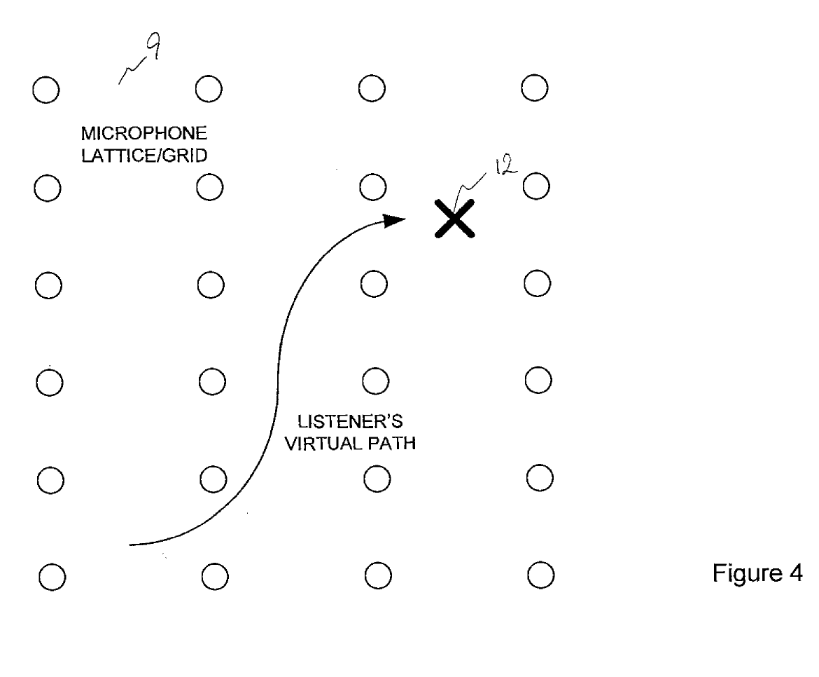

FIG. 4 illustrates a deterministic lattice of microphones 9, as may be used according to one embodiment of the present invention, placed around an area of interest. The area covered by the microphone lattice may be explored e.g. by moving a virtual listener position 12 around the space. Using information relating to the microphone configurations, such as the positions of the microphones relative to the desired listener position, it is possible to place the virtual listener within the area covered by the microphone array by selecting the relevant microphones.

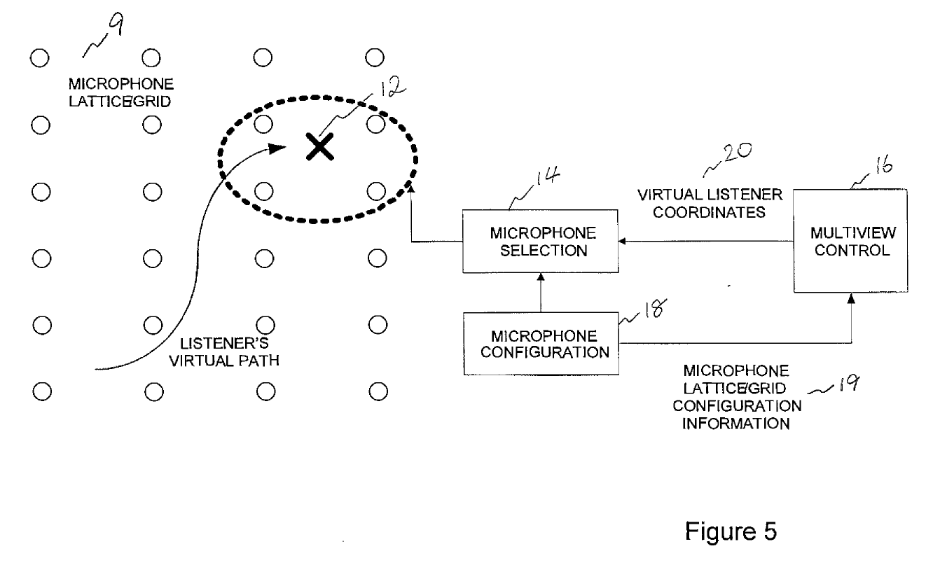

FIG. 5 illustrates a microphone selection routine in accordance with one embodiment of the present invention. A multiview controller 16, or simply a controller is provided in a receiver entity. Information relating to the microphone configuration 19 is provided to the multiview controller 16, by the microphone configuration store 18. The multiview controller may use the microphone configuration information 19 to determine desired virtual listener position 12 and orientation information related to the microphone configuration 9, and also movements of the virtual listener position 12 in the case of a dynamic rendering of the audio scene. The multiview controller 16 provides the virtual listener position information 20 to a microphone selector 14 in the audio capture entity.

The listener position may be determined using the microphone lattice/grid configuration and location information. The configuration and location information may need to be transmitted only once. Naturally, for a dynamic configuration, there needs to be an update whenever the information changes.

Thus, based on the virtual listener coordinates 20 provided by the multiview controller 16, and also on the microphone configuration information a subset of the microphones of the microphone lattice 10 may be selected to provide the required audio information to generate the desired audio scene. The microphone selector 14 may be considered to be a audiosource selector as it would typically, as shown below, be configured to select a subset of a plurality of the audio sources which are presented in this example as microphone sources.

The user does not need to know the microphone configuration. The control of the position, movement and orientation may be done based solely on the (a priori) known or perceived audio scene. Alternatively, the user may wish to select an absolute position, orientation or motion trajectory based on the known audio scene or location of interest. In this case the user may need to be aware of the space and the available multiview layout. The user may provide any such desired position, etc. to the multiview controller 16, which will then provide the necessary control and configuration signals to allow rendering of the desired audio scene.

Furthermore, according to one embodiment of the present invention, the number of microphones to be monitored may be controlled either from the far end or locally at the capture entity based on information provided by the receiver entity. The selection of the “wideness” of the captured audio scene could be based on the audio characteristics or audio content. For example, it may be desirable to capture the ambient noise with a plurality of microphones. In addition, several microphones could be utilised for enabling beam forming functionality later in the receiving entity based on the received multi channel content. Furthermore, it may be beneficial to utilise several microphones, i.e. input channels, in the presence of several different audio sources within the area of interest.

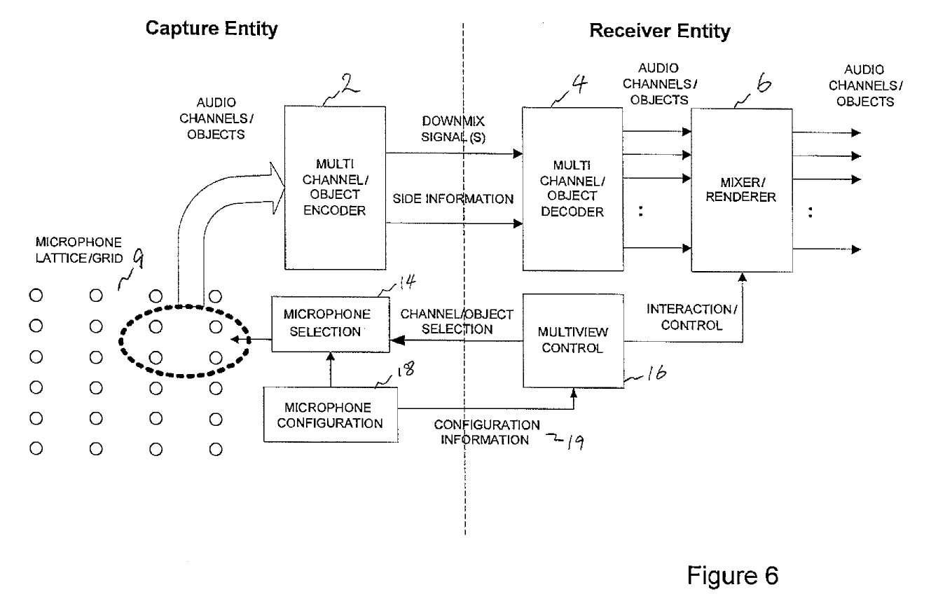

FIG. 6 presents a multiview audio capture, coding, transmission, rendering and control architecture according to one embodiment of the present invention. A subset of microphones (audio sources) from the microphone lattice 9 are selected based on a channel/object selection signal provided by the multiview controller 16 in the receiver entity by the microphone selection entity 14, as discussed above with reference to FIG. 5. The captured audio from the selected subset of microphones is then supplied to an encoder 2. The captured audio signals may be encoded by the encoder 2 using any multi channel audio coding scheme, in order to compress the signal for transmission. For example, MPEG surround, SAOC, DirAC or even conventional stereo codec (in case only two channels have been selected) could be applied. One or more discrete input channels could also be encoded with a mono codec or plurality of mono, stereo and multi channel codecs.

The corresponding decoder 4 synthesizes the multi channel content, to be used for rendering purposes, from the transmitted signal.

The decoded multi channel content provided by the decoder is applied to the mixer/renderer 6. The mixer/renderer may render the required audio scene based on the decoded audio channels and an interaction/control signal provided by the multiview control 16. The output of the audio mixer/renderer 6 may be either multi channel loudspeaker layout, such as a conventional 5.1 configuration as used in home theatre, or alternatively, the audio scene could be represented using headphones in which case the content is rendered to either stereo or binaural format. The number of output channels could also be limited to one if only one input channel is traced or a beam forming is conducted as a post processing operation in mixer/renderer 6.

The renderer 6 after the decoder 4 may be able to conduct beam forming (if the requirements for microphone locations are met) and/or panning of sources in such a manner that the listener is placed in the desired location relative to the microphone positions.

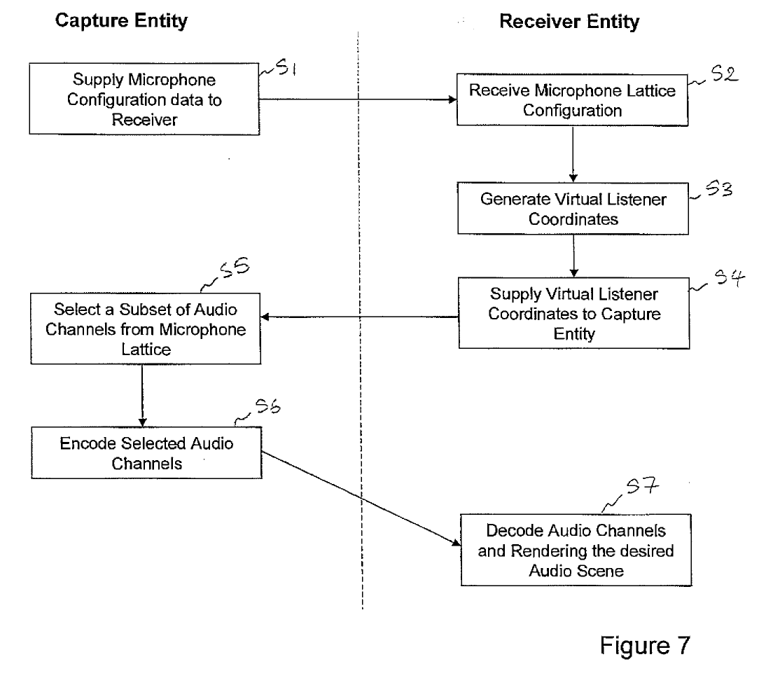

FIG. 7 illustrates a method according to one embodiment of the present invention. The method comprises supplying information relating to the audio sources (e.g. microphones) in S1, which is received in the receiver entity in S2. This information may then be used in the receiver entity in S3 to generate virtual listener coordinates which describe the desired position and orientation of the virtual listener within the audio scene being monitored. In other embodiments the virtual listener coordinates may be replaced by some other form of generated information related to a desired subset of the audio sources from the set of available audio sources. The virtual listener coordinates, or generated information, are then supplied to the capture entity in S4. The virtual listener coordinates (or generated information) and the information relating to the audio source configuration may then be used in S5 to select a subset of the available audio channels that are to be supplied to the receiver. In S6 the selected subset of the audio channels is encoded for transmission to the receiver. The transmitted encoded signals are received in the receiver entity and decoded in S7, and the decoded signals may then be used to render, or synthesize, the desired audio scene at the receiver.

Based on the decoded and rendered audio scene the user may interact with the system by changing the virtual listener position and orientation in S4 and consequently influence the selection of audio channels in the microphone lattice in S5. Furthermore, the system may automatically adjust the position and orientation based on the retrieved audio scene for example to better select the microphone configuration for the beam forming.

Embodiments of the present invention may provide one or more of the following advantages:
Any desired audio processing such as beam forming may be applied to the multi channel audio at the receiving end. It is thus possible to create several views on the audio content.
The multi channel and surround audio coding enables low bit rate transmission of the selected audio content. Furthermore, the number of channels to be included within the transmission could be selected based on user requirements or upon the audio conditions and content in existing at the place of interest.

In particular, in comparison with the prior art PAS (Personalized Audio Service) concept, some embodiments of the present invention allow the amount of data to be transmitted between the capture entity and the receiver entity to be significantly reduced, as it is only necessary to transmit those signals required by the receiver entity to render the desired audio scene.

The described embodiments may be applied to tele-presence and see-what-I-see services, allowing an audio scene to be reproduced at the receiver entity. Embodiments of the present invention may relate to speech and audio coding, media adaptation, transmission of real time multimedia over packet switched network (e.g. Voice over IP).

According to some embodiments of the present invention, the receiver entity may comprise a user equipment in a mobile network. Furthermore, said microphone lattice, may comprise an arbitrary lattice of any known type of audio sources covering the area of interest. Relative positional information for the microphone lattice may be pre-configured, or may be generated in real-time, for example using GPS.

It shall be appreciated that the term user equipment is intended to cover any suitable type of wireless user equipment, such as mobile telephones, portable data processing devices or portable web browsers.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

For example the embodiments of the invention may be implemented as a chipset, in other words a series of integrated circuits communicating among each other. The chipset may comprise microprocessors arranged to run code, application specific integrated circuits (ASICs), or programmable digital signal processors for performing the operations described above.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. A method comprising:
selecting a subset of audio sources from a plurality of audio sources;
transmitting signals from said selected subset of audio sources to an apparatus;
wherein said subset of audio sources is selected in dependence on information provided by said apparatus.

2. The method of claim 1, further comprising encoding said signals from said subset of audio sources before transmission.

3. The method of any previous claim wherein said plurality of audio sources comprises a plurality of microphones in a microphone lattice.

4. The method of any previous claim wherein said plurality of audio sources comprises a microphone array suitable for beam forming.

5. The method of any previous claim wherein said information provided by said apparatus comprises virtual listener coordinates.

6. The method of any of claims 1 to 4 wherein said information provided by said apparatus comprises audio source selection information.

7. The method of any previous claim further comprising providing configuration information relating to said plurality of audio sources to said apparatus.

8. The method of claim 7, wherein said information provided by said apparatus is generated in dependence on said configuration information relating to said plurality of audio sources.

9. The method of claim 7 or 8, wherein said configuration information comprises relative positional information relating to said audio sources.

10. The method of claims 7 to 9, wherein said configuration information comprises orientation information relating to said audio sources.

11. A method comprising:
generating information relating a desired subset of audio sources from a plurality of audio sources;
supplying said information to an apparatus; and
receiving signals transmitted by said apparatus.

12. The method of claim 11 further comprising decoding said received signals to synthesize a plurality of audio channels relating to said desired subset of audio sources.

13. The method of claim 12 further comprising rendering said synthesized audio channels to provide a desired audio scene.

14. The method of claim 11 or 12 wherein said information relating to a desired subset of audio sources comprises virtual listener coordinates.

15. The method of any of claims 11 to 13 wherein said information relating to a desired subset of audio sources comprises audio source selection information.

16. The method of any of claims 11 to 15 further comprising receiving configuration information relating to the configuration of said plurality of audio sources.

17. The method of claim 16, wherein said information relating to a desired subset of audio sources is generated in dependence on said configuration information.

18. The method of claim 16 or 17, wherein said configuration information comprises relative positional information relating to said audio sources.

19. The method of claims 16 to 18, wherein said configuration information comprises orientation information relating to said audio sources.

20. The method of claim 16 when dependent upon claim 13, wherein rendering said synthesized audio channels further comprises rendering said synthesized signals to provide a desired audio scene in dependence on said configuration information relating to said plurality of audio sources.

21. An apparatus comprising:
an audio source selector configured to select a subset of a plurality of audio sources in dependence on information provided by a further apparatus; and
an encoder configured to encode signals from said subset of audio sources and to transmit said encoded signal to said further apparatus.

22. The apparatus of claim 21 wherein said plurality of audio sources comprises a plurality of microphones in a microphone lattice.

23. The apparatus of claim 21 wherein said plurality of audio sources comprises a microphone array suitable for beam forming.

24. The apparatus of any of claims 21 to 23 wherein said information provided by said further apparatus comprises virtual listener coordinates.

25. The apparatus of any of claims 21 to 23 wherein said information provided by said apparatus comprises audio source selection information.

26. The apparatus of any of claims 21 to 25 further comprising a providing unit configured to provide configuration information relating to said plurality of audio sources to said further apparatus.

27. The apparatus of claim 26, wherein said configuration information comprises relative positional information relating to said audio sources.

28. The apparatus of claim 26 or 27 wherein said configuration information comprises orientation information relating to said audio sources.

29. An apparatus comprising:
a controller configured to provide information relating to a desired audio scene to a further apparatus; and
a decoder configured to receive an encoded signal from said further apparatus and decode the signal.

30. The apparatus of claim 29 further comprising a renderer configured to receive decoded signals from said decoder; and
wherein said controller is further configured to provide a control signal to said renderer;
said renderer further configured to generate a desired audio scene in dependence on said decoded signal and said control signal.

31. The apparatus of claim 29 or 30 wherein said information relating to a desired subset of audio sources comprises virtual listener coordinates.

32. The apparatus of claim 29 or 30 wherein said information relating to a desired subset of audio sources comprises audio source selection information.

33. The apparatus of any of claims 29 to 32, wherein said controller is further configured to receive configuration information relating to the configuration of said plurality of audio sources.

34. The apparatus of claim 33 wherein said configuration information comprises relative positional information relating to said audio sources.

35. The apparatus of claim 33 or 34 wherein said configuration information comprises orientation information relating to said audio sources.

36. An apparatus comprising:
controlling means for providing information relating to a desired audio scene to a further apparatus; and
decoding means for receiving an encoded signal from said further apparatus, and for decoding the signal.

37. An apparatus comprising:
selecting means for selecting a subset of a plurality of audio sources in dependence on information provided by a further apparatus; and
encoding means for encoding signals from said subset of audio sources and for transmitting said encoded signal to said further apparatus.

38. A computer program code means adapted to perform any of the steps of claims 1 to 20 when the program is run on a processor.

39. An electronic device comprising the apparatus as claimed in any of claims 21 to 37.

40. A chipset comprising the apparatus as claimed in any of claims 21 to 37.
